(19) United States
(12) Patent Application Publication
(10) Pub. No.: US 2022/0258555 A1
(43) Pub. Date: Aug. 18, 2022

(54) AUTOMOTIVE HYDRAULIC SHOCK ABSORBER

(71) Applicant: EVCO PRO 2018 LTD, Netanya (IL)

(72) Inventor: Evyatar COHEN, Moshav Elyashiv (IL)

(21) Appl. No.: 17/610,382

(22) PCT Filed: May 13, 2020
(86) PCT No.: PCT/IL2020/050517

§ 371 Date: Nov. 10, 2021

(30) Foreign Application Priority Data
May 16, 2019 (IL) 266688

(51) Int. Cl. B60G 13/08; B60G 17/08

(52) U.S. Cl. CPC B60G 13/08; B60G 17/08; B60G 2206/41; B60G 2800/162; B60G 2204/62; B60G 2500/114; B60G 2202/24

(57) ABSTRACT

An automotive hydraulic shock absorber, comprises a pressure cylinder, an auxiliary reservoir and a piston assembly, wherein said piston assembly comprises an annular piston comprised of a plurality of crossing flow ports on its upper and lower faces, a piston shaft, and shim stacks on both faces of said piston, partially or fully covering said flow ports, suitable to exert a resistance to the flow of hydraulic fluid in said pressure cylinder, when said piston travels through hydraulic fluid.

### FIELD OF THE INVENTION

The present invention relates to a shock absorber for automotive suspension systems. More particularly, the present invention relates to a hydraulic shock absorber with a novel piston assembly.

### BACKGROUND OF THE INVENTION

A moving wheeled vehicle is subject to various road conditions (e.g., bumps, pits, obstacles), in which at least one of the vehicle's wheels is shifted perpendicularly to the vehicle's travel direction. A moving wheeled vehicle is also subject to various driving situations (e.g., accelerations, decelerations, curves), in which the vehicle's body mass is shifted up or down related to its wheels. The perpendicular shifting of vehicle's wheels or body, affects vehicles' safety (i.e., vehicle's road grasp, stability and steering effectivity) and the comfort level of the vehicle's users.

Shock absorbers are used in vehicles' suspension systems in conjunction with springs, being connected (i.e., parallel or co-centrically installed) between vehicle's wheels and body. The relative linear displacement between vehicles' wheels and body induces contraction/extraction and rebound of a suspension spring and a parallel or co-centric shock absorber. While the spring's dimensions and rigidity determines the amplitude of relative wheel-body displacement, the shock absorber's design determines the allowable velocity and the oscillation of said displacement.

Shock absorbers of the prior art are comprised of a pressure cylinder and a piston assembly, in which an annular piston is comprised of a plurality of flow ports and with flexible shims in a stack arrangement (also referred as “shim stack”) on both faces of the piston (i.e., compression and rebound faces) are attached onto one end of a piston shaft and travels through hydraulic fluid contained by said pressure cylinder. The other end of said piston shaft is attached through a suspension member to the wheel (i.e., follows the wheel displacement) and the distal end of said pressure cylinder is attached to the vehicle's body.

The displacement of a piston within the shock absorber's cylinder is restrained by the drag forces induced by hydraulic fluid flowing through said piston's ports, while deflecting the edge of flexible shims (of the abovementioned shim stack) which partially covers said ports. In this manner, a portion of the shock energy, exerted by varying road and driving conditions is converted into heat which is transferred from the hydraulic fluid to the cylinder's shell and therefrom dissipates to the ambient environment. The flow characteristic in different wheel-body displacement amplitudes and velocities, determines the damping characteristic of a shock absorber and accordingly the suitability of a shock absorber to specific vehicles (i.e., according to their weight, design and intended use). Since most of the vehicles experience multiple driving conditions (i.e., driving an off-road vehicle on a highway, or traveling with a family car on a moderately unpaved trail), the choice of shock absorbers for a specific vehicle is typically made taking into account its main use and driving conditions, and making compromises on other possible but less common scenarios. Accordingly, a vehicle designed for off-road travel will be usually fitted with a shock absorber of characteristics very different from those of one intended for city and highway travel.

Presently, the market offers a large range of shock absorbers, comprising piston ports with varying contours, different diameters (varying, e.g., from 2″, 2.4″, 2.5″ and 3″), flexible shims of various shapes, locations and controllability, bypass channels through the piston and piston shaft and mono-tube and dual-tube cylinders with internal and external reservoirs. However, the need to design multiple types of shock absorbers results in expensive shock absorbers that are limited in application. It would therefore be highly desirable to provide shock absorbers that are more versatile and can offer good shock-absorbing ability through a range of driving conditions.

It is an object of the present invention to provide a novel shock absorber that offers flexible damping capability for broad driving and road conditions.

It is another object of the present invention to provide a shock absorber of a modular design which enables multiple design variations, suitable for various vehicle models and applications.

It is another object of the present invention to provide a shock absorber which permits to reduce heat accumulation, resulting in an extended service life compared with the prior art. Other objects and advantages of the invention will become apparent as the description proceeds.

### SUMMARY OF THE INVENTION

An automotive hydraulic shock absorber, comprising a pressure cylinder, an auxiliary reservoir and a piston assembly, wherein said piston assembly comprises:
a. an annular piston comprised of a plurality of crossing flow ports on its upper and lower faces, wherein:
   i) the upper face of said piston is provided with pairs of compression flow ports, consisting of a rounded, triangular-like shaped cavity located at its periphery, which are constructed asymmetrically, and further provided with a round opening near one of said cavity's extremities, such that it faces a corresponding round opening of the compression flow port to which it is paired, said upper face being further provided with round openings of the rebound flow ports originating at the bottom surface of said piston, and with bleed channels passing through the whole thickness of the piston;
   ii) the bottom face of said piston is provided with three rebound flow ports located on the circumference of said piston, which consist of a rounded elongated cavity having further a round opening that exceeds the boundaries of said cavity and crosses through to the upper face, said bottom face being further provided with the ends of three round openings of the compression flow ports originating at the upper surface, and with bleed channels passing through the whole thickness of the piston;
b. a piston shaft; and
c. shim stacks on both faces of said piston, partially or fully covering said flow ports, suitable to exert a resistance to the flow of hydraulic fluid in said pressure cylinder, when said piston travels through hydraulic fluid.

In one embodiment the shock absorber has three pairs of compression flow ports. In another embodiment it has three rebound flow ports. In a further embodiment the shock absorber has at least two bleed channels.

According to the invention within the total height of the piston, the height of the shaped cavity is greater than the height of the round opening. The opening at the shaped cavities are of a rounded shape, i.e., not shaped with straight corners, as will be apparent from the description of the drawings. Accordingly, in one embodiment the shaped cavities which face the compression (upper) side of the piston have a substantially round, triangular shape with round corners.

The shaped cavities are arranged in pairs located at the periphery of said piston. In one embodiment the shaped cavities which face the rebound (bottom) side of the piston have an elongated shape and have round openings exceeding their boundaries. According to one embodiment the elongated shape is an ellipsoid.

In an embodiment of the invention the diameter of the auxiliary reservoir connection to the pressure cylinder is approximately the diameter of the piston shaft.

### BRIEF DESCRIPTION OF THE DRAWINGS

FIG. 1 schematically shows a section view of an assembled shock absorber according to an embodiment of the present invention;

FIG. 2 schematically shows a view of the piston compression face according to another embodiment of the current invention;

FIG. 3 schematically shows a view of the piston rebound face of the piston of FIG. 2;

FIG. 4(a), (b), (c) are cross sections of the pistons of FIGS. 2 and 3, taken along the BB and CC planes, respectively;

FIG. 5 is a perspective view of the piston of FIGS. 2 and 3, showing the compression face of FIG. 2; and

FIG. 6 is an exploded view of a shock absorber cylinder assembly according to one embodiment of the invention.

### DETAILED DESCRIPTION OF ONE EMBODIMENT

The present invention relates to an automotive hydraulic shock absorber comprising a pressure cylinder containing hydraulic fluid, an auxiliary reservoir to which a portion of said hydraulic fluid flows back and forth as a result of the linear displacement of a piston assembly along the pressure cylinder.

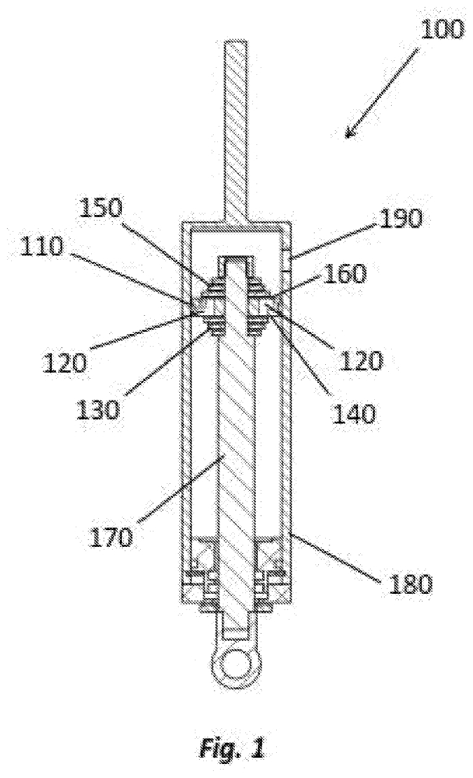

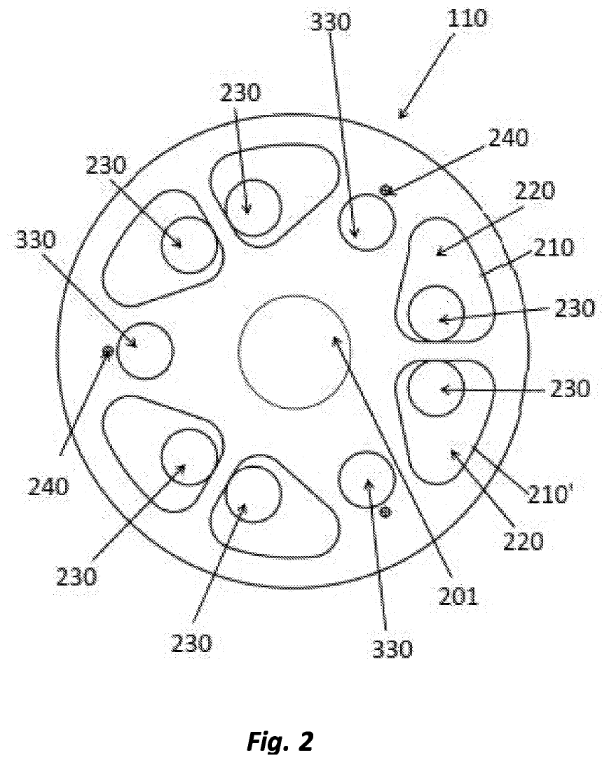

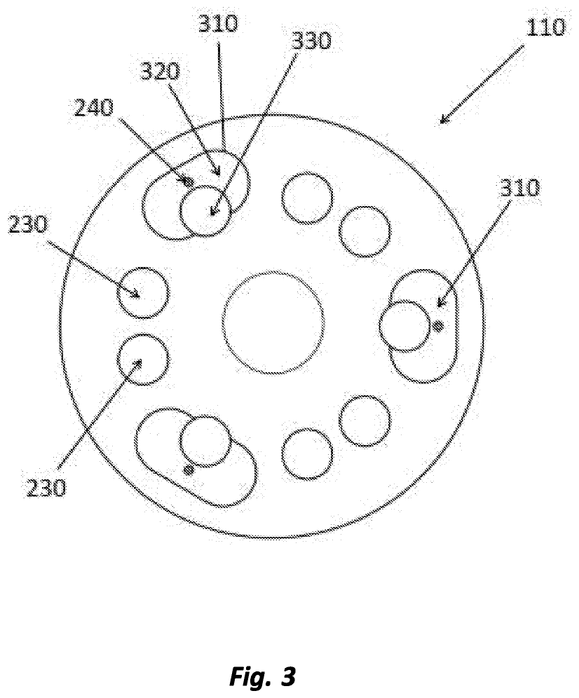

FIG. 1 shows a section view of an assembled shock absorber according to one embodiment of the present invention, in which shock absorber 100 comprises of an annular piston 110 provided with a plurality of crossing flow ports 120 described in detail in FIGS. 2 and 3, a compression shim stack 130 (consisting, in this particular illustrative embodiment, of 3 shims) on the bottom face 140 of the piston, and a rebound shim stack 150 on the top face 160 of the piston. Piston 110 and shim stacks 130 and 150 are provided with central holes suitable to accept one end of a piston shaft 170, located inside pressure cylinder 180 with an flow outlet 190 to an auxiliary reservoir (not shown), central home 201 being shown in FIG. 2.

FIG. 2 is a top view of a piston according to one embodiment of the present invention, in which the upper face of said piston is shown with three pairs of compression flow ports 210, located at the periphery of piston 110. As is easily seen in the figure, flow ports 210 are constructed asymmetrically and it has been surprisingly found that this asymmetry is important in providing the enhanced performance of the shock absorber. Compression flow ports 210 consist of a rounded, triangular-like shaped cavity 220, facing piston's upper face 160 of FIG. 1, and a round opening 230 near one of said cavity's extremities, such that its faces a corresponding round opening 230 of the compression flow port 210 to which it is paired (indicated in the figure as 210′ for clarity). This design allows an initial damping by the compression of a small quantity of hydraulic fluid which rapidly flows and accumulates in cavities 220 and in cylindrical openings 230, until the pressure is high enough to deflect the first shim of the compression shim stack 130 of FIG. 1, which partially covers the cylindrical openings 220 of compression flow ports 210. For example, small road obstacles at high vehicle's speed will result in small, yet rapid displacements of piston 110. Furthermore, the diameter of openings 230 can be made smaller than in comparable prior art pistons, as is the diameter of bleed holes 240 discussed below. Moreover, in some embodiments of the invention it is sufficient to provide only two bleed holes 240, and the actual number of said bleed holes can be adapted to the desired smoothness of operation of the shock absorber.

FIG. 2 also shows the ends of three round openings 330 of the rebound flow ports (shown in FIG. 3), and in this particular embodiment of the invention three bleed channels 240 which allow the free flow of fluid during low velocity displacements (e.g., during a vehicle's slow climbing on a parking ramp).

FIG. 3 is a bottom view of a piston of an embodiment of the present invention, in which the bottom face 140 (FIG. 1) of the piston is shown with three rebound flow ports 310 located on the circumference of piston 110, which consist of a rounded elongated cavity 320 having further a round opening 330 that exceeds the boundaries of cavity 320 and crosses through to the upper face, as seen in FIG. 2. This arrangement of cavities and openings allows an initial damping by the compression of a small quantity of hydraulic fluid which rapidly flows and accumulates in cavities 320 and round openings 330, until the pressure is high enough to deflect the first shim of the rebound shim stack 150 (which partially covers the cylindrical openings 320 of rebound flow ports 310).

FIG. 3 also shows the ends of three round openings of the compression flow ports (shown in FIG. 2), and three bleed channels 240 which allow the free flow during low velocity displacements.

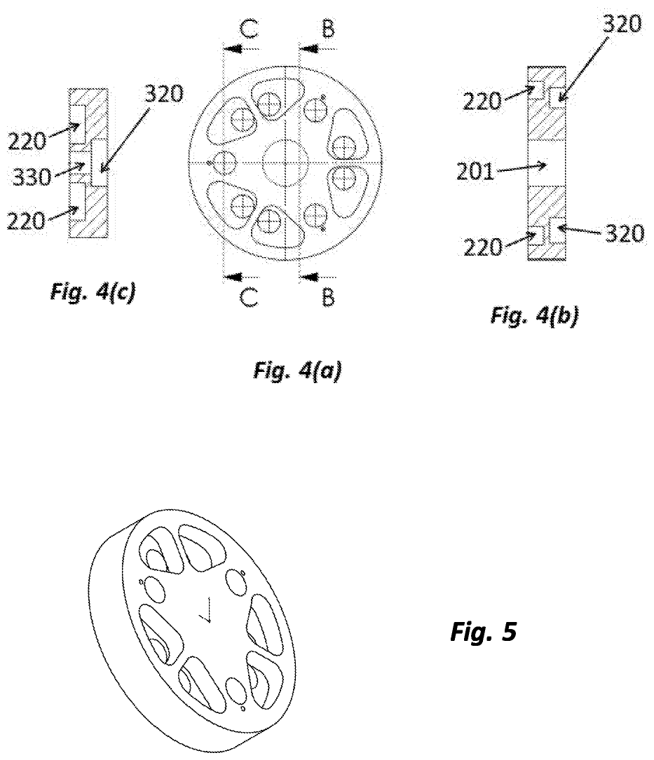

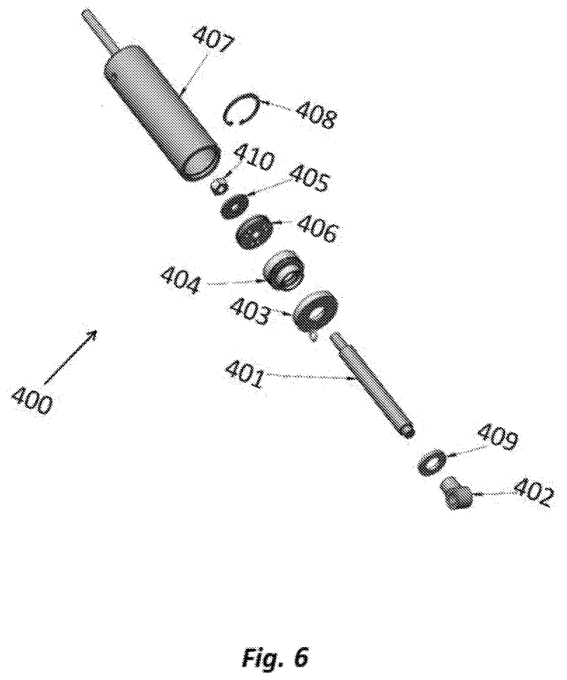

FIG. 4(b) is a cross-section of the piston of FIG. 4(a) taken along the BB plane, and FIG. 4(c) is a cross-section of the piston of FIG. 4(a) taken along the CC plane. Numerals in these cross sections are the same as in FIGS. 2 and 3.

FIG. 5 show a perspective view of the piston of FIGS. 2 and 3, with the central hole 201 removed and is provided to illustrate the tree-dimensionality of the opening provided in the piston.

The structure of the shock absorber of the invention allows for different scenarios. For example, an initial fast rebound of the vehicle's wheel (i.e., soft reaction of the shock absorber) passing a large bump, can be followed by either a continuous soft response at low vehicle's speed (i.e., hydraulic fluid free flow through bleed channels 240, or a firm response at high vehicle's speed (restrained flow through the flow ports).

The aforesaid compression and rebound response of the shock absorber of the invention also enable a high definition response, i.e., the initial reaction to a large obstacle at high vehicle's speed will be soft (i.e., high flow rate of a limited quantity of fluid through said piston and to auxiliary reservoir 160, and as the displacement continues, the response gets firmer (i.e., higher resistance to flow through piston's flow ports 210 or 310 and to auxiliary reservoir 160). Furthermore, the high definition response through multiple flow channels improves the heat distribution and reduces the accumulation of heat, hence contributing to an improved service life of the shock absorber.

FIG. 4 is an exploded view of a shock absorber 400 according to one embodiment of the invention. It comprises a shaft 401, a lower base 402, a cover 403. A sealing part 404, a bottom plat 405, a piston 406, a cylindric housing 407, a snap ring 408, a plain washer 409, and a fastening nut 410. Some non-essential elements are not shown. The shock absorber assembly shown in FIG. 4 is a typical assembly but of course many variations to this structure can be provided, as will be well understood by the skilled person.

Table 1 illustrates the different parameters for the piston of FIGS. 2 and 3, when used in conjunction with different types of suspensions and for vehicles of different weight. Each shim stack (also sometimes referred to as “pyramid”) starts in this example with a shim having a diameter of 1.6″, with the following at least 6 shims in the stack decreasing in diameter.

TABLE 1

| Vehicle | Compression | Rebound | |
|---|---|---|---|
| weight | Stack - Shim | Stack - Shim | Type of |
| (Tons) | thickness | thickness | suspension |
| 1-1.5 | 0.008″ | 0.006″ | Active axle |
| 1.5-2 | 0.010″ | 0.010″ | Active axle + separate |
| | | | suspensions |
| 2-2.5 | 0.010″ | 0.012″ | Active axle + separate |
| | | | suspensions |
| 2.5-3.5 | 0.012″ | 0.012″ | Active axle |
| 2.5-3.5 | 0.010″ | 0.020″ | Separate suspensions |
| 3.5-4 | 0.012″ | 0.015″ | Active axle + separate |
| | | | suspensions |

The modular design of the shock absorber of the invention allows shock absorber manufacturers to produce one common model of a shock absorber with a single piston and with multiple optional shim stacks arrangements, suitable to a broad range of vehicle models and applications. Designing different shim stacks for different purposes is well known in the art and, therefore, is not discussed herein for the sake of brevity.

Although embodiments of the invention have been described by way of illustration, it will be understood that the invention may be carried out with many variations, modifications, and adaptations, without exceeding the scope of the claims.

1. An automotive hydraulic shock absorber, comprising a pressure cylinder, an auxiliary reservoir and a piston assembly, wherein said piston assembly comprises:
a. an annular piston comprised of a plurality of crossing flow ports on its upper and lower faces, wherein:
i) the upper face of said piston is provided with pairs of compression flow ports, consisting of a rounded, triangular-like shaped cavity located at its periphery, which are constructed asymmetrically, and further provided with a round opening near one of said cavity's extremities, such that it faces a corresponding round opening of the compression flow port to which it is paired, said upper face being further provided with round openings of the rebound flow ports originating at the bottom surface of said piston, and with bleed channels passing through the whole thickness of the piston;
ii) the bottom face of said piston is provided with three rebound flow ports located on the circumference of said piston, which consist of a rounded elongated cavity having further a round opening that exceeds the boundaries of said cavity and crosses through to the upper face, said bottom face being further provided with the ends of three round openings of the compression flow ports originating at the upper surface, and with bleed channels passing through the whole thickness of the piston;
b. a piston shaft; and
c. shim stacks on both faces of said piston, partially or fully covering said flow ports, suitable to exert a resistance to the flow of hydraulic fluid in said pressure cylinder, when said piston travels through hydraulic fluid.

2. The shock absorber of claim 1, having three pairs of compression flow ports.

3. The shock absorber of claim 1, having three rebound flow ports.

4. The shock absorber of claim 1, having at least two bleed channels.

5. The shock absorber of claim 1, in which within the total height of the piston, the height of the shaped cavity is greater than the height of the round opening.

6. The shock absorber of claim 1, in which the opening at the shaped cavities are of a round shape.

7. The shock absorber of claim 1, in which the shaped cavities which face the compression (upper) side of the piston have a substantially round, triangular shape with round corners.

8. The shock absorber of claim 7, in which the shaped cavities are arranged in pairs located at the periphery of said piston.

9. The shock absorber of claim 1, in which the shaped cavities which face the rebound (bottom) side of the piston have an elongated shape and have round openings exceeding their boundaries.

10. The shock absorber of claim 1, in which the elongated shape is an ellipsoid.

11. The shock absorber of claim 1, in which the diameter of the auxiliary reservoir connection to the pressure cylinder is approximately the diameter of the piston shaft.
